(19) United States
(12) Patent Application Publication
(10) Pub. No.: US 2020/0306772 A1
(43) Pub. Date: Oct. 1, 2020

(54) METHOD FOR PRODUCING SHOWER NOZZLE

(71) Applicant: XIAMEN OSHINCE TECHNOLOGY CO., LTD., Xiamen (CN)

(72) Inventors: Deqing Yang, Xiamen (CN); Quansen Hu, Xiamen (CN)

(21) Appl. No.: 16/365,679

(22) Filed: Mar. 27, 2019

(51) Int. Cl. B05B 1/18

(52) U.S. Cl. CPC B05B 1/18

(57) ABSTRACT

This invention discloses a method for producing a shower nozzle which includes following steps of perforating a water outlet plate by laser in order to form a plurality of water outlet holes, welding a joint head and the water outlet plate to a casing, and polishing a welding portion where the joint head and the water outlet plate are welded to the casing before executing a surface treatment. This invention integrates the water outlet holes with the water outlet plate through laser perforation, then polishing the surface after welding each component together into one, thereby executing the surface treatment at one time, simplifying the process, increasing the efficiency, and achieving the seamless surface and color constancy.

### BACKGROUND OF THE INVENTION

### 1. Field of the Invention

This invention relates to a shower nozzle and relates particularly to a method for producing a shower nozzle.

### 2. Description of the Related Art

A shower nozzle which is common shower equipment in a bathroom can adjust a direction of water outlet and water yield and produce different water splashes to meet shower needs of different people.

A conventional shower nozzle is assembled from multiple components which generally include a water outlet plate, a casing, a joint head and other functional components. A surface treatment is executed to these components separately to result in complicated process and reduced efficiency. Meanwhile, separate surface treatment causes the whole appearance of the shower nozzle to become inconsistent and results in the color aberration. Further, seams are formed at joints where the components connect. The appearance of the shower nozzle will form obvious seams even if the surface treatment is executed at one time. Conventional water outlet holes of the shower nozzle are performed through installing a water outlet member on the water outlet plate. However, the water outlet member and the water outlet plate are not united together and the water outlet member is mostly made of soft plastic, thus it cannot be processed under high temperature.

Therefore, the inventor has meditated the deficiencies and inconveniences caused by the unfinished problems, and actively researched, improved and tested to further develop and devise this invention.

### SUMMARY OF THE INVENTION

The object of this invention is to provide a method for producing a shower nozzle capable of solving problems of a complicated process of the surface of the conventional shower nozzle and the color aberration of the surface of the product, achieving one-time surface treatment of the product, increasing the production efficiency, and maintaining the color constancy of the surface of the product.

In order to achieve the aforesaid object, the solution of this invention is:

A method for producing a shower nozzle comprising:

step 1, a step of producing components of a shower nozzle which include a water outlet plate, a casing and a joint head by a mold;

step 2, a step of perforating the water outlet plate by laser in order to form a plurality of water outlet holes on the water outlet plate;

step 3, a step of welding the joint head to the casing and welding the water outlet plate to the casing.

step 4, a step of polishing a welded portion where the joint head and the water outlet plate are welded to the casing in order to obtain a semi-finished product; and

step 5, a step of treating the semi-finished product polished in the step 4 with a surface treatment.

Preferably, in the step 1, a thickness of the water outlet plate is between 0.6 and 1.5 millimeters.

Preferably, in the step 2, an area of each water outlet hole is between 0.05 and 0.15 square millimeters.

Preferably, the surface treatment includes a vacuum plating process and an ion plating process.

After adopting the above method, this invention perforating the surface of the water executes by laser to form the water outlet holes and unites the water outlet holes and the water outlet plate together into one to avoid the influence of the surface treatment. This invention combines each component together by welding and executes the polishing treatment to keep the consistent surface, allow the one-time surface treatment, simplify the production process, and increase the production efficiency. The surface of the semi-finished product is formed without seams to achieve the seamless surface and color constancy after executing the surface treatment.

### BRIEF DESCRIPTION OF THE DRAWINGS

FIG. 1 is an exploded view showing the product of this invention which is not perforated;

FIG. 2 is a schematic view showing the perforation pattern of the water outlet plate of this invention;

FIG. 3 is a schematic view showing the combination of each component of this invention; and

FIG. 4 is a perspective view showing the semi-finished product of this invention.

### DETAILED DESCRIPTION OF THE PREFERRED EMBODIMENTS

In order to further explain the technical solution of this invention, the invention is described in detail through the specific embodiment as follows.

A method for producing a shower nozzle comprising:

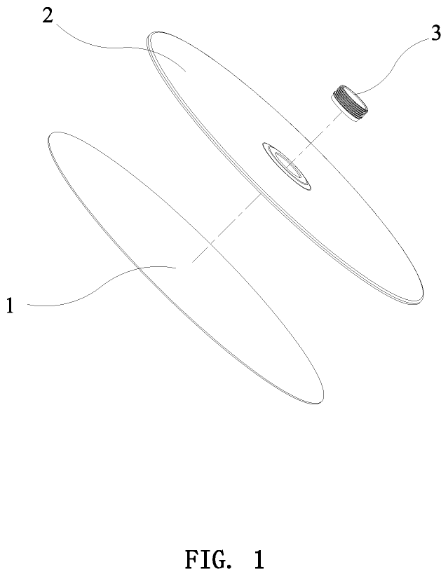

step 1, a step of producing components of a shower nozzle which include a water outlet plate 1, a casing 2 and a joint head 3 by a mold as shown in FIG. 1. A thickness of the water outlet plate 1 is between 0.6 and 1.5 millimeters;

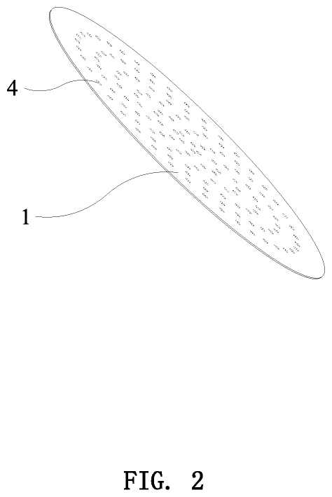

step 2, as shown in FIG. 2, a step of perforating the water outlet plate 1 by laser according to the predetermined pattern of the water outlet in order to form a plurality of water outlet holes 4 on the water outlet plate 1. An area of each water outlet hole 4 is between 0.05 and 0.15 square millimeters;

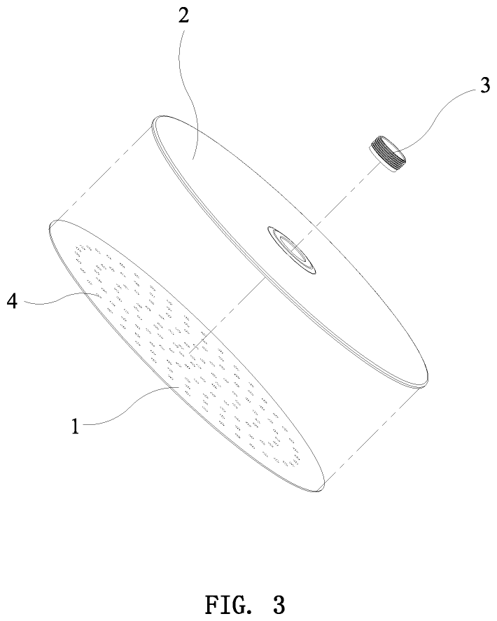

step 3, as shown in FIG. 3, a step of welding the joint head 3 to the corresponding position of the casing 2 and welding the water outlet plate 1 to the corresponding position of the casing 2;

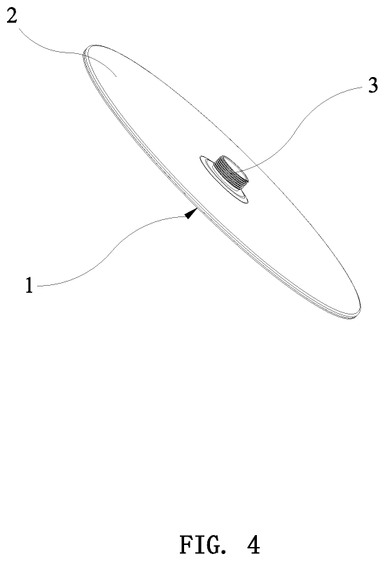

step 4, a step of polishing a welding portion where the joint head 3 and the water outlet plate 1 are welded to the casing 2 in order to obtain a semi-finished product as shown in FIG. 4 to allow the surface of the semi-finished product to maintain smooth and consistent; and

step 5, a step of treating the semi-finished product polished in the step 4 with a surface treatment such as a vacuum plating process and an ion plating process to form a coating.

Through the above method, this invention perforates the surface of the water outlet plate 1 by laser to form the water outlet holes 4 and unites the water outlet holes 4 and the water outlet plate 1 together into one to avoid the influence of the surface treatment. This invention combines each component by welding and executes the polishing treatment to keep the consistent surface and execute the surface treatment at one time, thereby simplifying the production process and increasing the production efficiency. The surface of the semi-finished product is formed without seams, thereby achieving the seamless surface and color constancy after executing the surface treatment.

What is claimed is:

1. A method for producing a shower nozzle comprising:
step 1, a step of producing components of a shower nozzle which include a water outlet plate, a casing and a joint head by a mold;
step 2, a step of perforating said water outlet plate by laser in order to form a plurality of water outlet holes on said water outlet plate;
step 3, a step of welding said joint head to said casing and welding said water outlet plate to said casing;
step 4, a step of polishing a welded portion where said joint head and said water outlet plate are welded to said casing in order to obtain a semi-finished product; and
step 5, a step of treating said semi-finished product polished in said step 4 with a surface treatment.

2. The method as claimed in claim 1, wherein in said step 1, a thickness of said water outlet plate is between 0.6 and 1.5 millimeters.

3. The method as claimed in claim 1, wherein in said step 2, an area of each of said plurality of water outlet holes is between 0.05 and 0.15 square millimeters.

4. The method as claimed in claim 1, wherein said surface treatment includes a vacuum plating process and an ion plating process.
